(19) United States
(12) Patent Application Publication
(10) Pub. No.: US 2025/0054353 A1
(43) Pub. Date: Feb. 13, 2025

(54) Gaming Systems with Overlay Prize Symbols Overlaying Moving Underlying Prize Award Symbols

(71) Applicant: Aristocrat Technologies Australia Pty Limited, North Ryde (AU)

(72) Inventors: Joshua Matos, Cordeaux Heights (AU); Geoffrey Richardson, Baulkham Hills (AU); Rajni Choudhary, Haryana (IN)

(21) Appl. No.: 18/428,947

(22) Filed: Jan. 31, 2024

(30) Foreign Application Priority Data
Aug. 10, 2023 (AU) 2023214325

(51) Int. Cl. G07F 17/32

(52) U.S. Cl. CPC G07F 17/3213

(57) ABSTRACT

A gaming device is disclosed comprising a display, a random number generator, a processor, and memory storing (i) reel strip data defining prize award reel strips, and (ii) instructions. When the instructions are executed, they cause the processor to control the display to display a plurality of columns of symbol positions, control the display to display overlay prize symbols at least a subset of the symbol positions, each overlay prize symbol indicating a prize value and enabling a view of an underlying symbol the display, select stopping positions for the prize award reel strips, control the display to display the prize award reel strips stopped at the selected positions, and upon a prize award symbol being displayed at a symbol position at which an overlay prize symbol is displayed when the prize award reel strips are displayed as stopped, and make an award of at least the prize value.

### RELATED APPLICATION

The present application claims priority to Australian Application No. AU 2023214325, filed Aug. 10, 2023, and entitled “Gaming Device with Overlay Prize Symbols,” which is hereby incorporated by reference in its entirety.

### BACKGROUND

The present application relates to a gaming device, a method of operating a gaming device and a system with overlay prize symbols.

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return-to-player), or a return-to-player target (RTP target), over the course of many plays or instances of the game. The RTP target and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

There is disclosed a gaming device, a method of operating a gaming device and a system having an additional prize award mechanic where prize values of overlay prize symbols added to a displayed game outcome independently of selection of symbols from reel strips are awarded upon a prize award symbol being selected from the reel strips at a same symbol position.

An example embodiment describes a gaming device A gaming device is disclosed comprising a display, a random number generator, a processor, and memory storing (i) reel strip data defining prize award reel strips including prize award symbols, and (ii) instructions. When the instructions are executed by the processor, they cause the processor to control the display to display a plurality of columns of symbol positions, control the display to display overlay prize symbols at least a subset of the symbol positions, each overlay prize symbol indicating a prize value and enabling any underlying symbol to be viewed on the display, select, using the random number generator, stopping positions for the prize award reel strips relative to the symbol positions, control the display to display the prize award reel strips stopped at the selected stopping positions, and upon a prize award symbol being displayed at a symbol position at which an overlay prize symbol is displayed when the prize award reel strips are displayed as stopped, make an award of at least the prize value indicated by the overlay prize symbol.

Another example embodiment describes a method of operating a gaming device comprising a display, a random number generator and memory storing reel strip data defining prize award reel strips including prize award symbols. The method comprises controlling the display to display a plurality of columns of symbol positions, controlling the display to display overlay prize symbols at least a subset of the symbol positions, each overlay prize symbol indicating a prize value and enabling any underlying symbol to be viewed on the display, selecting, using the random number generator, stopping positions for the prize award reel strips relative to the symbol positions, controlling the display to display the prize award reel strips stopped at the selected stopping positions, and upon a prize award symbol being displayed at a symbol position at which an overlay prize symbol is displayed when the prize award reel strips are displayed as stopped, making an award of at least the prize value indicated by the overlay prize symbol.

Another example embodiment describes a system comprising at least one display, a random number generator, one or more processors, and at least one memory storing reel strip data defining prize award reel strips including prize award symbols, and instructions. When the instructions are executed by the one or more processors, they cause the one or more processors to control the at least one display to display a plurality of columns of symbol positions, control the at least one display to display overlay prize symbols at least a subset of the symbol positions, each overlay prize symbol indicating a prize value and enabling any underlying symbol to be viewed on the display, select, using the random number generator, stopping positions for the prize award reel strips relative to the symbol positions, control the display to display the prize award reel strips stopped at the selected stopping positions, and upon a prize award symbol being displayed at a symbol position at which an overlay prize symbol is displayed when the prize award reel strips are displayed as stopped, make an award of at least the prize value indicated by the overlay prize symbol.

Embodiments of the disclosure also provide a gaming device that includes a display operable to display a plurality of symbol positions, and a gaming controller having a processor and memory storing data indicative of a plurality of prize award reel strips including a plurality of prize award symbols, and instructions. When executed, the instructions cause the processor to control the plurality of symbol positions to animate at one or more of a plurality of overlay prize symbols, the plurality of overlay prize symbols having a plurality of prize values, respectively, and enabling an underlying symbol to be viewable on the display, respectively. Following the display of the overlaying prize symbols, the display animates the prize award reel strips having prize award symbols being spun and stopped at a plurality of stopping positions selected for the prize award reel strips with respect to the symbol positions using a random number generated by a random number generator and a weighted table, and animates a win indicative of the prize values on the overlay prize symbols at the symbol positions that overlay the prize award symbols at the stopping positions selected.

Other embodiments of the disclosure also provide a method of animating an award on a gaming device. The method may include animating at a plurality of symbol positions on the gaming device one or more of a plurality of overlay prize symbols, the overlay prize symbols displaying prize values and enabling an underlying symbol to be viewable on the display. The method may also include animating on the gaming device a plurality of prize award symbols on a plurality of prize award reel strips underlying one or more of the plurality of overlay prize symbols, the plurality of prize award symbols on the plurality of prize award reel strips being selected using a random number generated by a random number generator and a weighted table, and animating on the gaming device a win indicative of the prize values on the overlay prize symbols corresponding to the prize award symbols underlying the overlay prize symbols.

Still other embodiments of the disclosure also provide a non-transitory computer-readable medium comprising a plurality of instructions, for conducting a game on a gaming system including a display and a game controller. The instructions, when executed, cause the game controller to perform the steps of controlling the display to animate at a plurality of symbol positions one or more of a plurality of overlay prize symbols, the plurality of overlay prize symbols having a plurality of prize values, respectively, and enabling an underlying symbol to be viewable on the display, controlling the display to underlay the plurality of symbol positions with a plurality of prize award symbols on a plurality of prize award reel strips selected using a random number generated by a random number generator and a weighted table, and controlling the display to animate a win indicative of the prize values on the plurality of overlay prize symbols corresponding to the plurality of prize award symbols selected at the plurality of symbol positions.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 2D illustrates, in block diagram form, an implementation of a game processing architecture algorithm that implements a game processing pipeline for the play of a game in accordance with various implementations described herein.

FIG. 3 illustrates an example reel strip layout.

FIG. 4 is a flow chart of a symbol selection method.

FIG. 5 is a flow chart of a method of operating a gaming device.

FIG. 6 is another flow chart of a method of operating a gaming device.

FIGS. 7 to 14 are example screen displays.

### DETAILED DESCRIPTION

Embodiments of the present disclosure represent an improvement in the art of electronic gaming machines, devices, systems, and software for such electronic gaming machines, devices, or systems. Specifically, the implementations illustrated address the technical problem of controlling volatility to meet one or more target thresholds that may include a designated or target RTP, a target game outcome, a target game payout, a target game volatility, a target win liability, a target maximum win liability, and the like, in an electronic gaming device. In this regard, a gaming establishment may consider controlling volatility to meet a targeted RTP such that a maximum win liability, which refers to a maximum payout based on a game outcome, stays within a predetermined amount. For example, in jurisdictions, such as Australia and Illinois, a game cannot exceed the maximum liability, and thus, requiring game designers to implement mechanism to ensure the maximum payout does not exceed a certain predetermined amount. For example, at least some embodiments of the present disclosure employ a display that provides a configuration of overlaying prize symbols and a visual modification of underlying prize award symbols at a plurality of columns of symbol positions during an iterative game to award one or more prizes associated with the columns of display positions. By configuring the plurality of overlay prize symbols on the display before selectively controlling the columns of symbol positions to display a number of underlying prize award symbols, appropriate and target RTP's and awards can be controlled and distributed. Further, upon a trigger condition being controllably met, the display may be configured to graphically transition to animate a different set of overlaying prize symbols being spun and stopped at one or more of the symbol positions, and to animate a different set of underlying prize award symbols at the symbol positions to effect additional control over appropriate RTP's and awards. Multiple visual modifications of underlying prize award symbols and overlaying prize symbol also provide a simplified player experience such that a player may only need to focus on changing of winning patterns, without being overly burdened by complicated calculations, while the RTP's and awards are technically controlled.

Further, embodiments of the present disclosure also provide certain payouts that are not conventional, as those that utilize memory to store symbol data for multiple overlaying prize symbol sets and underlying prize award symbol sets, such that one or more of these multiple sets is used to determine symbols to be selected for various symbol positions and in various columns. Thus, embodiments of the present disclosure are not merely new game rules or simply new display patterns, but provide technological improvements in the art of electronic gaming machines and software for such electronic gaming machines. Moreover, the above example is not intended to be limiting, but merely exemplary of technologic improvements provided by some embodiments of the present disclosure. Technological improvements of other embodiments are readily apparent to those of ordinary skill in the art in light of the present disclosure.

Examples of the technology relate to an electronic gaming device having an additional prize award mechanic. In examples, the gaming device has a display, a random number generator, a processor; and a memory storing (i) reel strip data defining prize award reel strips including prize award symbols, each prize award symbol having a prize value, and (ii) executable instructions. When the processor executes the instructions the cause the processor to (in some game instances) to control the display to display a plurality of columns of symbol positions, and control the display to display overlay prize symbols at least a subset of the symbol positions, each overlay prize symbol indicating a prize value. Executing the instructions also causes the processor to use the random number generator to select stopping positions for the prize award reel strips reel strips relative to the symbol positions and control the display to display the prize award reel strips reel strips stopped at the selected stopping. When a prize award symbol is displayed at a symbol position at which an overlay prize symbol is displayed when the prize award reel strips are displayed as stopped, the process makes an award of at least the prize value indicated by overlay prize symbol.

In some examples, if the prize award symbol is a multiplier prize award symbol, the processor makes an award of a value of the overlay prize symbol multiplied by a value of the multiplier.

In some examples, the overlay prize symbols are displayed in response to a trigger condition being met in a base game instance. In some examples, the instructions cause the processor to display overlay prize symbols at symbol positions in at least some base game instances and award at least the prize value indicated by overlay prize symbol when a prize award symbol is displayed at a symbol position at which an overlay prize symbol is displayed.

Further, the visual overlaying of one or more prize symbols by visually displaying underlying prize award symbols beneath the prize symbols provides an improved electronic game machine display such that the player may only need to direct attention to the overlaying prize symbols being displayed and differently overlaying the prize award symbols, and the visual animations used to display overlay prize symbols and underlying prize award symbols obtain a better outcome and engage the player, without being overly burdened by complicated calculations or repeated reference to game rules.

Also, the graphical user interface employing the illustrated implementations can improve the usability of electronic gaming devices by extending play time on the electronic gaming devices, and maintaining the interest of current players in the electronic gaming devices, which thereby enhances the user experience for players. Thus, implementations of the present disclosure are not merely new game rules or simply new display patterns, but provide technologic improvements to gaming technology in the art of electronic gaming devices and software for such electronic gaming devices.

Moreover, the above example is not intended to be limiting, but merely exemplary of technologic improvements provided by some implementations of the present disclosure. Technological improvements of other implementations are readily apparent to those of ordinary skill in the art in light of the present disclosure.

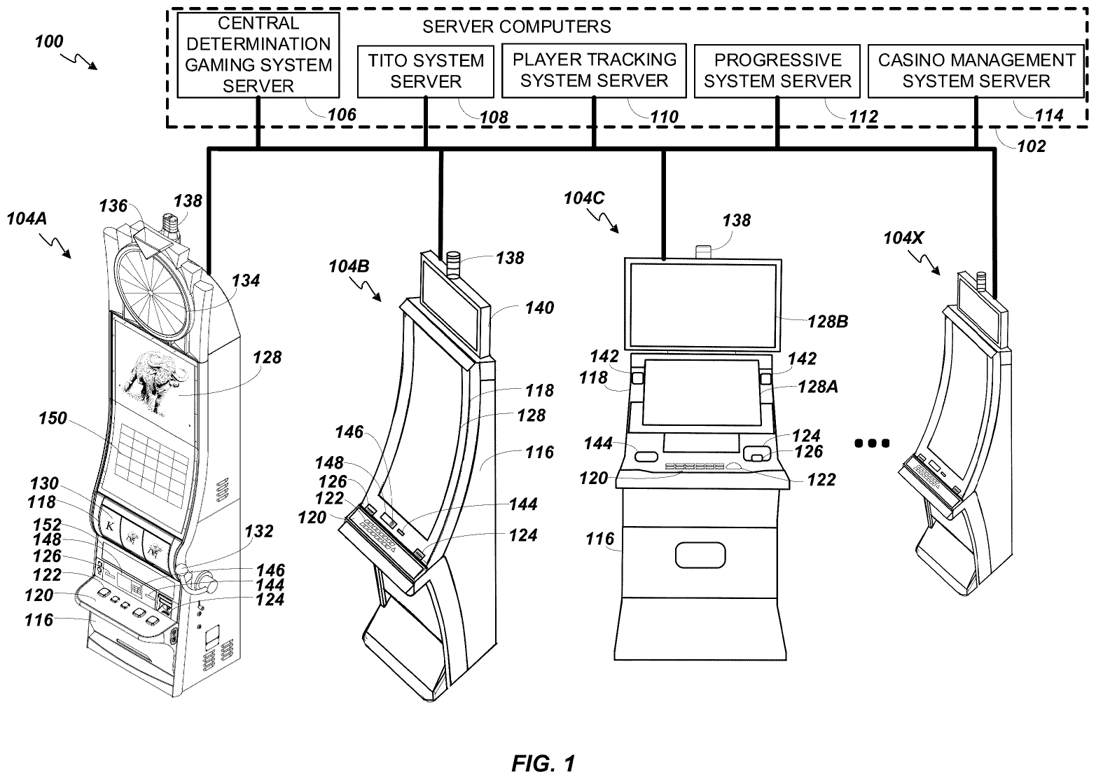

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Other servers (not shown) may be employed to execute other game operations, e.g., a bingo server. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel (any of which may be flat, curved, combinations of both flat and curved), a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

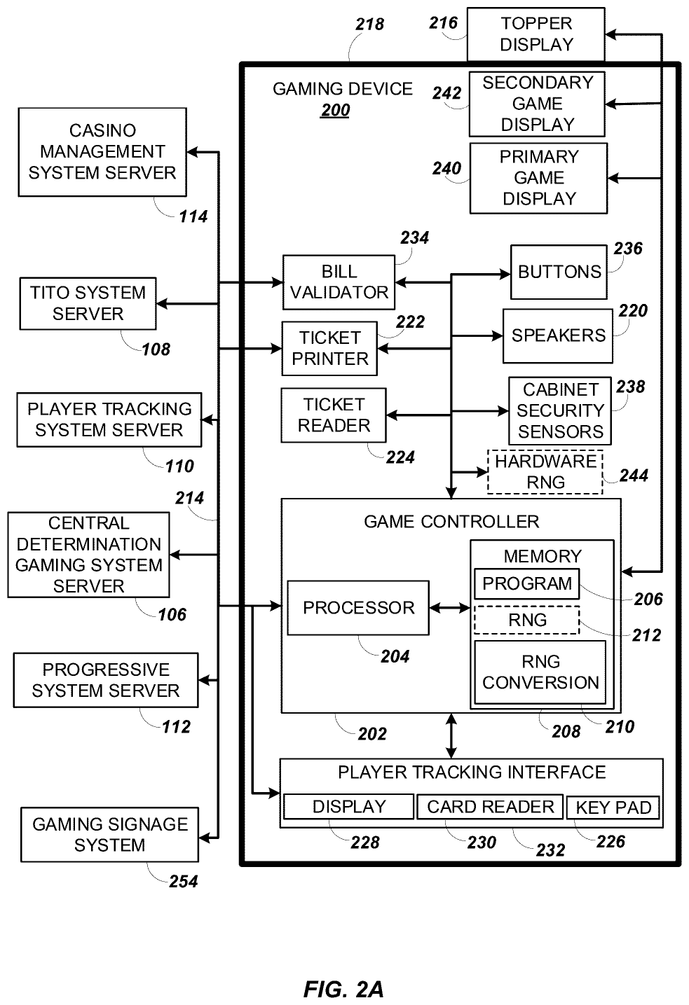

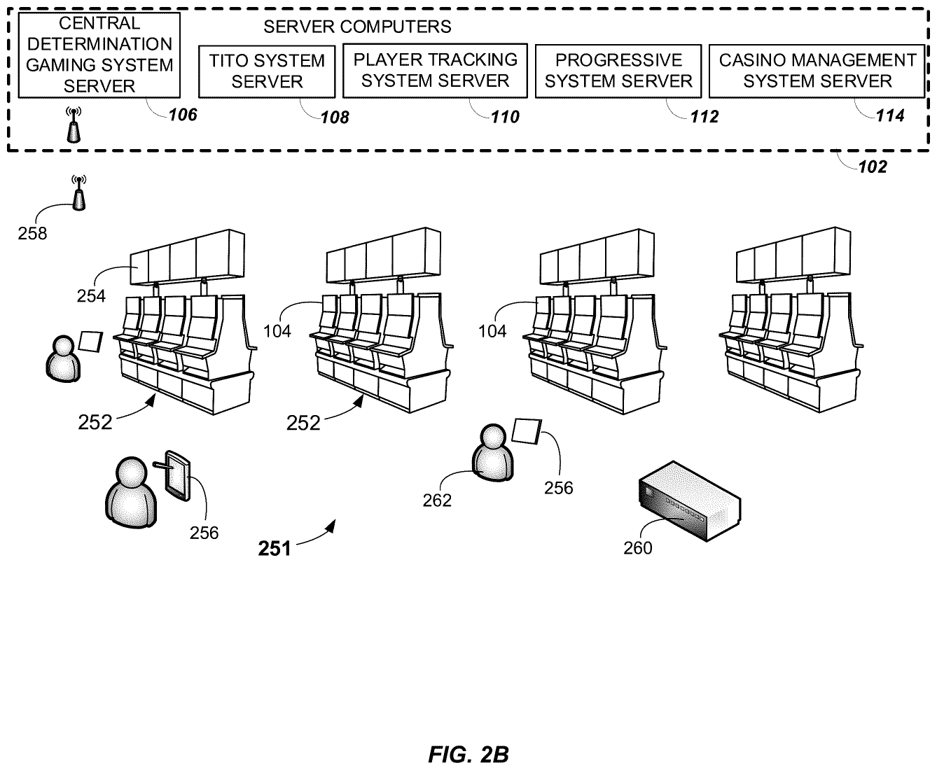

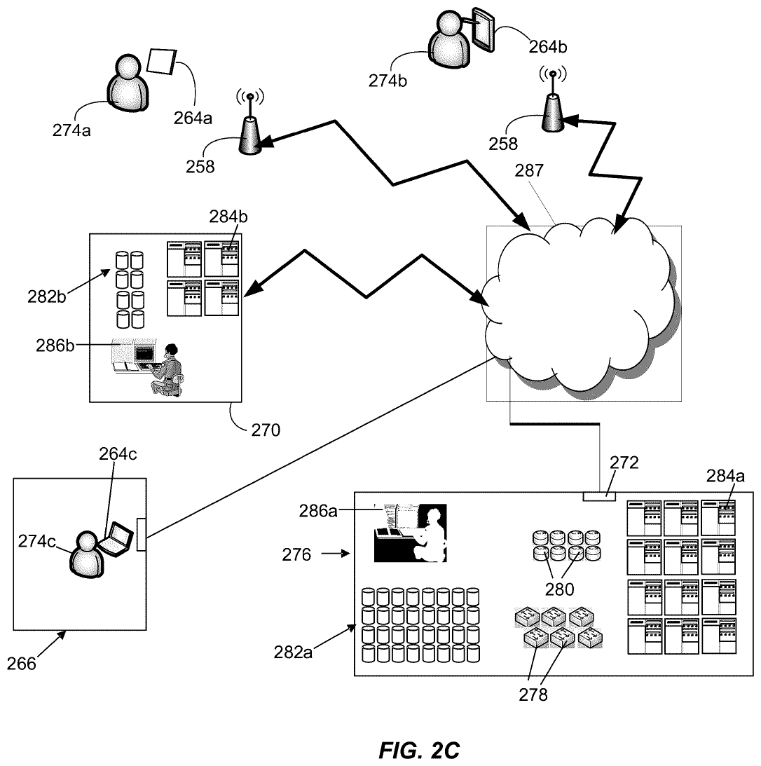

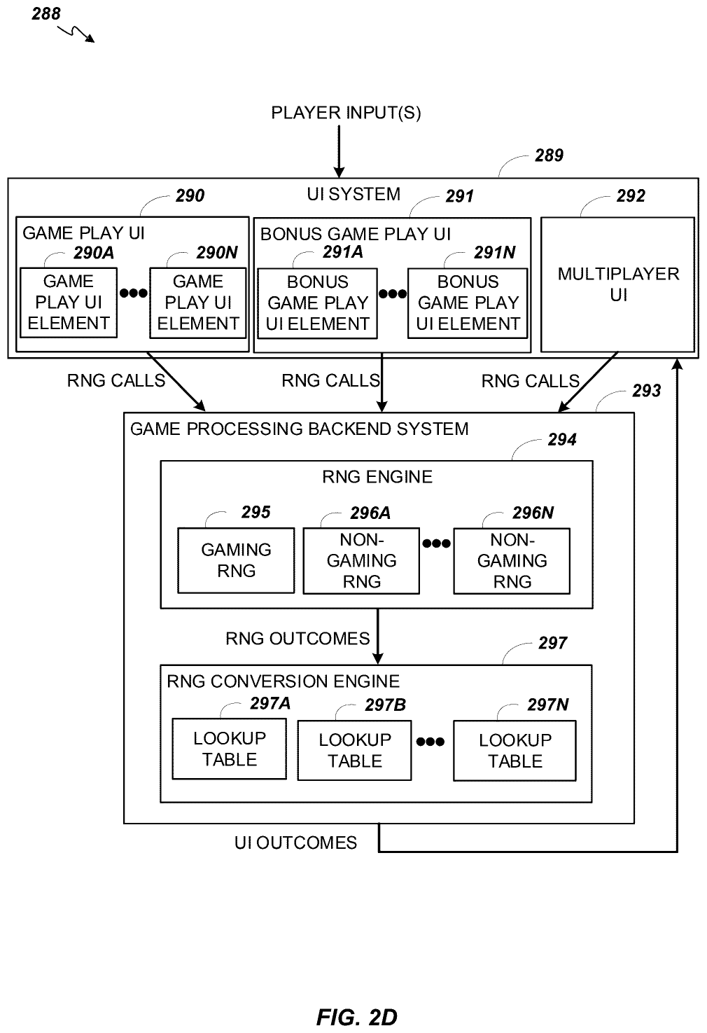

Many or all the above described components can be controlled by circuitry (e.g., a game controller) housed inside the main cabinet 116 of the gaming device 104A, the details of which are shown in at least FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. Other bill validator 124 or other credit input mechanisms may also be employed, for example, a card reader for reading a smart card, debit card or credit card, or arrangements to interact with a digital wallet or the like. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects may be channeled to the player with a technically improved user interface, which simultaneously controllably synchronizes presenting different awardable symbol types and credit values to the player with visual and auditory effects to engage the player. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2A. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2A are examples to facilitate case of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 287. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

FIG. 2D illustrates, in block diagram form, an implementation of a game processing architecture 288 that implements a game processing pipeline for the play of a game in accordance with various implementations described herein. As shown in FIG. 2D, the gaming processing pipeline starts with having a UI system 289 receive one or more player inputs for the game instance. Based on the player input(s), the UI system 302 generates and sends one or more RNG calls to a game processing backend system 293. Game processing backend system 293 then processes the RNG calls with RNG engine 294 to generate one or more RNG outcomes. The RNG outcomes are then sent to the RNG conversion engine 297 to generate one or more game outcomes for the UI system 289 to display to a player. The game processing architecture 288 can implement the game processing pipeline using a gaming device, such as gaming devices 104A-104X, 200 shown in FIGS. 1 and 2A, respectively. Alternatively, portions of the gaming processing architecture 288 can implement the game processing pipeline using a gaming device and one or more remote gaming devices, such as central determination gaming system server 106 shown in FIG. 1.

The UI system 289 includes one or more UIs that a player can interact with. The UI system 289 could include one or more game play UIs 290, one or more bonus game play UIs 291, and one or more multiplayer UIs 292, where each UI type includes one or more mechanical UIs and/or graphical UIs (GUIs). In other words, game play UI 290, bonus game play UI 291, and the multiplayer UI 292 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 2D as an example, the different UI elements are shown as game play UI elements 290A-290N and bonus game play UI elements 291A-291N.

The game play UI 290 represents a UI that a player typically interfaces with for a base game. During a game instance of a base game, the game play UI elements 290A-290N (e.g., GUI elements depicting one or more virtual reels) are shown and/or made available to a user. In a subsequent game instance, the UI system 289 could transition out of the base game to one or more bonus games. The bonus game play UI 291 represents a UI that utilizes bonus game play UI elements 291A-291N for a player to interact with and/or view during a bonus game. In one or more implementations, at least some of the game play UI element 290A-290N are similar to the bonus game play UI elements 291A-291N. In other implementations, the game play UI element 290A-290N can differ from the bonus game play UI elements 291A-291N.

FIG. 2D also illustrates that UI system 289 could include a multiplayer UI 292 purposed for game play that differs or is separate from the typical base game. For example, multiplayer UI 292 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 294 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 2D does not explicitly depict that multiplayer UI 292 includes UI elements, multiplayer UI 292 could also include one or more multiplayer UI elements.

Based on the player inputs, the UI system 289 could generate RNG calls to a game processing backend system 293. As an example, the UI system 289 could use one or more application programming interfaces (APIs) to generate the RNG calls. To process the RNG calls, the RNG engine 294 could utilize gaming RNG 295 and/or non-gaming RNGs 296A-296N. Gaming RNG 295 could corresponds to RNG 212 or hardware RNG 244 shown in FIG. 2A. As previously discussed with reference to FIG. 2A, gaming RNG 295 often performs specialized and non-generic operations that comply with regulatory and/or game requirements. For example, because of regulation requirements, gaming RNG 295 could correspond to RNG 212 by being a cryptographic RNG or pseudorandom number generator (PRNG) (e.g., Fortuna PRNG) that securely produces random numbers for one or more game features. To securely generate random numbers, gaming RNG 295 could collect random data from various sources of entropy, such as from an operating system (OS) and/or a hardware RNG (e.g., hardware RNG 244 shown in FIG. 2A). Alternatively, non-gaming RNGs 296A-296N may not be cryptographically secure and/or be computationally less expensive. Non-gaming RNGs 296A-296N can, thus, be used to generate outcomes for non-gaming purposes. As an example, non-gaming RNGs 296A-296N can generate random numbers for generating random messages that appear on the gaming device.

The RNG conversion engine 297 processes each RNG outcome from RNG engine 294 and converts the RNG outcome to a UI outcome that is feedback to the UI system 289. With reference to FIG. 2A, RNG conversion engine 297 corresponds to RNG conversion engine 210 used for game play. As previously described, RNG conversion engine 297 translates the RNG outcome from the RNG 212 to a game outcome presented to a player. RNG conversion engine 297 utilizes one or more lookup tables 297A-297N to regulate a prize payout amount for each RNG outcome and how often the gaming device pays out the derived prize payout amounts. In one example, the RNG conversion engine 297 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 293 sends the UI outcome to the UI system 289. Examples of UI outcomes are symbols to display on a video reel or reel stops for a mechanical reel. In one example, if the UI outcome is for a base game, the UI system 289 updates one or more game play UI elements 290A-290N, such as symbols, for the game play UI 290. In another example, if the UI outcome is for a bonus game, the UI system could update one or more bonus game play UI elements 291A-291N (e.g., symbols) for the bonus game play UI 291. In response to updating the appropriate UI, the player may subsequently provide additional player inputs to initiate a subsequent game instance that progresses through the game processing pipeline.

A brief description of electronic gaming reel games follows. Implementations described herein can be implemented in a gaming server 102 and/or gaming device 104A, 104B, 104C, 104X, 200 as described with reference to FIGS. 1 and 2A. Thus, a gaming server 102 or gaming device 104A, 104B, 104C, 104X, 200 is an example of an electronic gaming device as described. The game processing backend system and graphical user interface system can be implemented using memory and one or more processors that are part of the electronic gaming device and/or part of a gaming system located remotely from the electronic gaming device. Depending on implementation, the backend system and graphical user interface system can be implemented by software executable on a CPU, by software controlling special-purpose hardware (e.g., a GPU or other graphics hardware for video acceleration), and/or by special-purpose hardware (e.g., in an ASIC), to process game play instructions in accordance with game play rules, determine outcomes in accordance with game play rules, and/or generate outputs (e.g., to one or more display screens and/or speakers).

Electronic gaming devices can incorporate implementations described herein into various types of reel games or other games. A reel game can be a base mode or feature mode (e.g., free game or bonus game mode). A reel game uses spinning reels and one or more reel windows, e.g., reel window 150 on a display screen 128 in FIG. 1.

A base mode includes play that involves a sequence of reel spins, reel stops and win determinations of the stopped reels. That is, a single play of a reel game can constitute a single complete game or wager, e.g., a single spin of the reels or a series of spins and reel stops which culminate in a final aggregate outcome.

A feature mode can, among other things, add the possibility of winning alternative payouts potentially involving different target volatility criterion than the base game. A feature mode typically does not require an additional wager, but certain feature modes may require additional wagers.

As shown in FIG. 1, the reel game may include a display 128 with a reel window 150. The reel window 150 is configured to display at least viewable portions of a set of reels associated with the reel window 150. For each of the reels, the viewable portion of the reel includes a plurality of positions for one or more instances of symbols from a symbol set. Thus, the game window 150 may display a matrix of one or more symbol positions containing one or more symbol instances on a display 128, and may be highlighted graphically to emphasize one or more reels, symbol positions and/or symbol instances within the reel window 150. The number of reels and dimensions of the reel window 150 depend at least on display and the game implementation employed.

In some arrangements, the reel window 150 displays y reels with x symbol positions visible to the player. This display of y reels with x symbol positions may be referred to as a reel array. Of course, different reels can have different counts of symbol positions and, in turn, symbol instances possible.

For example, a reel window 150 displays 5 symbol positions for a first reel, a second reel, a third reel, a fourth reel, and a fifth reel. Such a configuration can be described as a 5-5-5-5-5 configuration. For a typical game in base mode, reel window 150 may display a 5×3 configuration having five reels per window, with three symbol positions showing in the window for each of the reels.

Other game array configurations are possible. For example, more generally, the reel window 150 may accommodate a reel array that spans m reels in a first dimension and spans n visible symbol positions in a second dimension orthogonal to the first dimension, where the value of m can be 4, 5, 6, 7, 8, or some other number of reels, and the value of n can be 2, 3, 4, 5, 6, or some other number of symbol positions.

Typically, the m reels are arranged horizontally in the reel window 150 from left-to-right, with the m reels spinning vertically and the reel window 150 showing symbol positions of each of the visible portions of the respective reels. Alternatively, the m reels are arranged vertically in the reel window 150 from top-to-bottom, with the m reels spinning horizontally and the reel window 150 displaying symbol positions of each of the portions of the visible respective reels. Alternatively, a reel window 150 can have other configurations.

For each of the reels, a reel strip includes z total positions along a one-dimensional strip of symbol positions, where z depends on implementation. For example, z may be 30, 70, 100, 140, or some other number of positions. Different sets of reels can be used for a base mode, feature mode or other gaming mode. For example, for a feature mode, more valuable symbols, such as a WILD symbol or a SCATTER symbol, can be added to the reels to trigger or enhance play of the feature mode. The value of z can be the same or different for different reels (thus, different reels can have different numbers of symbol positions).

In some implementations, the configuration of the symbol instances at the symbol positions of the reel strips for the reels of a reel game is fixed after the reel mode is initiated (e.g., boots), although limited reconfiguration operations may be permitted. In other implementations, the configuration of the symbol instances at the symbol positions of the reel strips for the reels of a reel game can change dynamically after the reel mode is initiated. The dynamic change could depend on bet amount or some other factor(s), for example.

The symbol set for the reels may comprise various types of symbols. For example, symbol set may comprise a plurality of symbols, including a plurality of game symbols, a plurality of trigger symbols and a plurality of special symbols. The symbols can be static or animated. Depending on the application, the symbol set for the reels may comprise one or more special symbol types, at least one JACKPOT symbol type, a WILD symbol type, some number of picture symbol types, some number of game/low symbol types, and a SCATTER symbol type (which may, for example, trigger bonuses).

By way of an illustrative example, the symbol types may be various lower-value symbol types of different denominations (shown as other animals, numbers, card values), a WILD symbol (shown as a stylized WILD), a SCATTER symbol, a symbol for free games (e.g., infinite free games) and include a high-value symbol (shown as a Buffalo symbol). The SCATTER symbol is a dynamic symbol that is resolved to one of several different SCATTER symbol types (shown as a regular coin, a super coin, or one of several different jackpot coins) upon a spin. Alternatively, other and/or additional symbol types can be used. One or more “WILD WILD” symbol combinations are utilized in some instances to trigger a feature mode. Various jackpot symbols and combinations thereof may be used to trigger wheel award progressive and other progressive multipliers, for example.

A symbol set for the reels can also include other and/or additional symbols. In general, for a given type of symbol, one or more instances of the symbol can appear in a reel strip, but games can have different constraints on symbol placement. The symbol set can be the same or different between a game in the base mode and a game in the feature mode. Some types of symbols are dimmed out (not active at times).

Depending on context, the term “symbol” can indicate a symbol type or a symbol instance. In general, a WILD symbol instance can substitute for any other symbol (except, in most implementations, a SCATTER symbol or jackpot symbol) when determining win conditions along pay lines. In general, a SCATTER symbol instance can contribute to a win condition even if it is not on the same pay line as another scatter symbol. In some implementations, a win condition depends on a game instance count of a SCATTER symbol that occurs anywhere within a reel array, regardless of where they land within the reel array.

As in a reel game with physical reels, the reels of a reel game on a display 128 “spin” graphically through a reel window 150 on the display screen 128 to render partially visible the reel strips, when a player actuates a “spin” or “play” button, which acts as a “handle pull” event. The backend system randomly selects symbol positions of reel strips at which to stop the reel strips for the respective reels, and the respective reels stop at the selected symbol positions of the reel strips, with some number of symbol positions visible in the game window for each of the reels. For example, for a given reel, the backend system to the game machine generates a random number and determines a symbol position or symbol instance at which to stop the reel strip of the reel using the random number (e.g., with a lookup table). The backend system to the game machine may generate a different random numbers for the respective reels that are spun. In this way, the backend system to the game machine can determine which symbol positions (and, in turn, symbol instances) of the respective reels are visible in the reel window 150 on the display screen 128.

In other scenarios, symbol instances visible in a reel window 150 can be “transferred” or moved (e.g., drag and dropped by the player's touch) from another reel window 150 when certain conditions are satisfied. For example, symbol instances can be graphically transferred or otherwise added to the reel window 150 for a feature mode game from a base mode game upon the occurrence of certain conditions for the base mode game.

Generally, the backend system may determine various outcomes and perform operations for various types of games in the base mode and feature mode. For example, for various types of events, the backend system, e.g., as in FIG. 2D, uses an RNG (which can be a cryptographic RNG or PRNG) to generate a random number and that maps the random number to an outcome using a lookup table. This series of operations is generally referred to as an RNG operation. A graphical user interface of the gaming device can then output a display or other indications of those outcomes and perform operations.

FIG. 2D shows examples of lookup tables 297A-297N. These lookup tables 297A-297N may comprise weighted tables.

Generally, a lookup table can be implemented to assign probabilities to different possibilities, in order for one of the different possibilities to be selected using a random number. Different possibilities are represented in different entries of a lookup table. The probabilities for different possibilities can be reflected in threshold values. By way of example, for a random number RND, generated by an RNG, in the range 0<RND<=100, with four possibilities, 0<RND<=30 for entry 1, 30<RND<=65 for entry 2, 65<RND<=92 for entry 3, and 92<RND<=100 for entry 4). The threshold values can represent percentages or, more generally, sub-ranges within the range for a random number.

In some implementations, the threshold values for a lookup table are represented as weights (sometimes referred to as count values) for the respective entries of the lookup table. For example, the following table shows weights for the four possibilities described above:

TABLE 1
Exemplary Lookup Table

| Weight | Entry |
|---|---|
| 30 | <value 1A; value 2A . . . > |
| 35 | <value 1B; value 2B . . . > |
| 27 | <value 1C; value 2C . . . > |
| 8 | <value 1D; value 2D . . . > |

The backend system can use a random number, generated between 1 and the sum total of the weights, to select one of the entries in the lookup table by comparing the random number to successive running totals. In the example shown in Table 1, if the random number is 30 or less, the first entry is selected. If the random number is between 30 and 65, the second entry is selected, and, if the random number is between 65 and 92, the third entry is selected. Otherwise, the last entry is selected.

The lookup table threshold values for a lookup table can vary dynamically (e.g., depending on bet amount). The lookup table threshold values can also be fixed and predetermined. Or, a lookup table can be dynamically selected (e.g., depending on bet amount, depending on another factor) from among multiple available lookup tables. Different choices or parameters during game play can use different lookup tables. Or, different combinations of choices or parameters can be combined in entries of a given lookup table.

In general, after reels have stopped (landed) in reel window 150, any win conditions can be determined and selected win amounts can be awarded to the player (e.g., credited to the player's credit balance). In some examples, win conditions depend on a count of particular symbol instances in a reel window 150.

In other examples, win conditions are defined as combinations of symbol instances along pay lines (also called win lines) across at least a visible portion of a reel array on a display screen 128. A pay line is commonly traversed from one side of the reel window 150 to the opposite side of the reel window 150 (e.g., left to right), using one symbol instance per reel along the pay line as part of possible combinations of symbol instances. When a certain combination of symbol instances appears along a pay line, a win amount corresponding to that combination of symbol instances and that pay line is awarded for that round of play.

Win amounts can vary according to the combination of symbol instances and according to the particular pay line along which the combination of symbol instances appears. Win amounts are typically determined according to a pay table, where the pay table assigns the various combinations of symbol instances and pay lines that may occur (win condition possibilities). The win amount for a round of play may be a fraction of an amount wagered for that round of play for certain win conditions. For other win conditions, the win amount may be much larger than the amount wagered.

The number of pay lines and base credit cost to play depends on implementation. There can be 2×, 3×, 4×, and 5× bet multipliers. Multipliers can also appear as symbols in reels. Alternatively, there could be higher bet multipliers, different credit options, and/or a different number of pay lines.

Depending on the implementation, symbol instances along a pay line can be counted in different ways. For example, when evaluating a win condition along a pay line, only symbol instances along the pay line in adjacent reels are counted. On the other hand, when evaluating a win condition along a pay line, symbol instances along the pay line in any reel can be counted, even if the reels are not adjacent. For a given pay line, only the highest-paying combination of symbol instances is awarded. Alternatively, for a given pay line, all possible combinations of symbol instances are awarded, in the aggregate. A given symbol instance (e.g., wild symbol) is counted only towards its highest-paying combination in a given pay line. Alternatively, a given symbol instance can be counted towards multiple combinations in a given pay line.

An award can alternatively be determined according to a “ways” approach. This approach is sometimes referred to as a “ways evaluation.” For a ways evaluation, each possible path through designated (active) symbol display position(s) of the respective reels provides a way to win. A path is traversed from one side of the reel array to the opposite side of the reel array (e.g., typically left to right), using one symbol instance per reel along the path. For one symbol instance per reel in a combination, any symbol instance displayed at an active symbol display position for a given reel in the reel array can be used to form a symbol instance combination with any symbol instance displayed at an active display position of each of the other reels. The designated (active) symbol display positions for the respective reels can be pre-defined and static. For example, the designated (active) symbol display positions for each reel can be all of the symbol display positions enclosed in a reel window 150 for the reel. Or, the designated (active) symbol display positions for the respective reels can change, e.g., depending on a bet amount.

As a result, the total number of ways to win is determined by multiplying the number of active display position(s) of each reel. For example, for five reels each showing four symbol instances at active display positions in a reel window 150, there are 4⁵=1024 ways to win for all-ways evaluation. As another example, for five reels, with the first and second reels each showing three symbol instances and the remaining reels each showing four symbol instances at active display positions in the reel window 150, there are 3×3×4×4×4=576 ways to win for all-ways evaluation.

A player can choose a bet denomination (e.g., one cent, two cents, five cents) or use a default bet denomination for a base reel game. The player can also choose a bet amount (e.g., different amounts of credits) or use a default bet amount. The bet amount may affect the number of reels that are selected for all-ways evaluation-from one reel up to five reels, depending on the bet amount. The player can also choose a bet multiplier (e.g., 1×, 2×, 3×, 4×, 5×) or use a default bet multiplier (e.g., lx). Alternatively, other bet settings, evaluation approaches, etc. can be used.

The player initiates a spin for the base reel game (e.g., pushing a spin button). The spin uses the bet denomination, bet amount, and bet multiplier in effect (either default or selected by the player), assuming credits are sufficient in a credit meter. The credit meter decreases by the bet size.

In one example, for the spin of the reels in the base mode, a check may be made whether a feature mode is triggered. In particular, a random number may be generated, and the random number is mapped to an outcome (i.e., that the feature mode is triggered, or that the feature mode is not triggered) using a lookup table. The lookup table that is used can depend on the bet amount. In this example, as the bet amount increases, the feature mode is more likely to be triggered, as reflected in weights for the possible outcomes in different lookup tables for different bet amounts. Alternatively, the feature mode can be triggered in some other way, e.g., by the occurrence of a game element, like the occurrence of a designated or predetermined symbol or set of symbols, or by the occurrence of a non-game occurrence.

As discussed, a feature mode may be awarded or triggered in an electronic gaming device. The feature mode may improve the technology of the electronic gaming device with the additional elements of chance, e.g., a Cash-on-Reel (COR) feature. The feature mode can utilize controls, different sets of reels, display screens, symbols, etc. than the base mode does in its normal operation.

Alternatively, the feature mode can reuse or reconfigure at least some of the reels, display screens, symbols, etc. of a base reel game. The feature mode can be started in response to satisfaction of a trigger condition. For example, the feature mode can be initiated upon the occurrence of some defined combination of symbol instances, or a threshold count of certain symbol instances in one or more sets of reels. Alternatively, the feature mode can be triggered in some other way (e.g., randomly).

In some implementations, if at least a threshold count (e.g., three or more) of instances of a scatter symbol (coin, super coin, or jackpot) land in any position, a free games feature may be triggered. In a free game mode, the player is prompted to start the free games feature, and a transition to the free games feature occurs.

In one example, once a free games feature starts, the free games feature may continue without an input event. In other exemplary alternatives, one or more spins of the free games feature may be started or initiated in response to a user input event. The free games feature continues until all free games (spins) have been used. The number of free games depends on the count of instances of a scatter symbol that have landed to trigger the free games feature. The number of free games can be increased if the free games feature is “re-triggered” from within the free games feature.

The outcome of the spin is then determined using all-ways evaluation, generally as described above for the base reel game. Alternatively, outcome evaluation can be performed using a different approach for a spin of the free games feature. In any case, after the outcome evaluation for a spin, any credits from winning combinations of symbol instances are shown in a win meter. The free games feature continues in a cycle of spin/stop/outcome evaluation until there are no more free games (spins). After the outcome evaluation for all spins of the free games feature, the total from the win meter is added to a credit meter and the free game feature reverts to the base or other game mode.

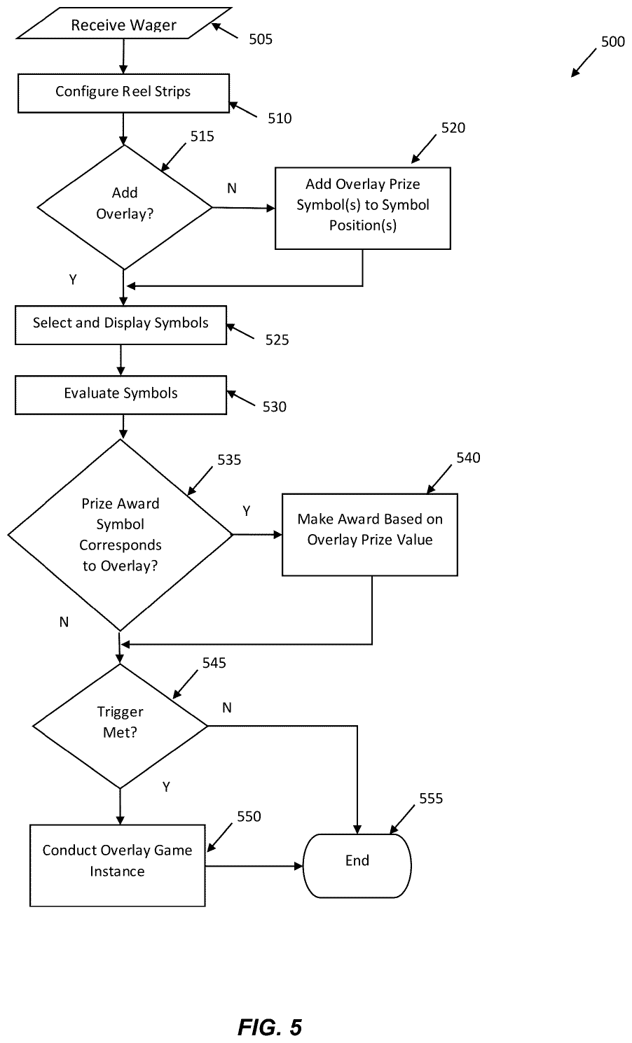

FIG. 5 is a flow chart of an example embodiment of a method 500 of operating a gaming device. At step 505, processor 204 initiates a first game instance (e.g. a base game) in response to receiving a wager (e.g. in response to a player making a wager selection using buttons as described above).

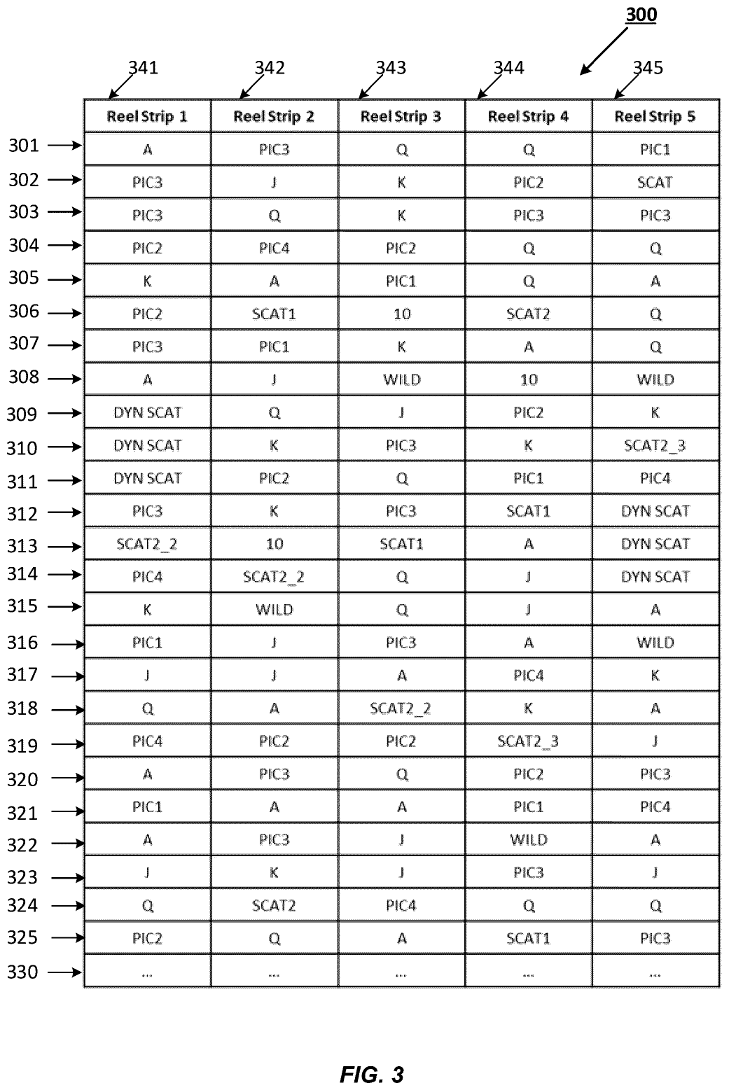

FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a symbol. For example, a “Wild” symbol occupies the twenty-first reel strip position 321 of the fourth reel 344. The symbols shown on the reel strip are generally indicative of symbols that may be employed in example embodiments but it will be appreciated that there visual appearance and the composition will depend on factors such as the visual theme of the game and a desired return-to-player, or the return-to-player target (RTP target). For this reason, generic names are given for some of the symbols in FIG. 3. In this example, the symbols include:
1. SCAT1—used to trigger the free games feature. (“SCAT” indicates a scatter symbol that does not need to be on a pay line to cause an award to be made by processor 204, in this example, award of the free games feature upon a threshold number of SCAT1 symbols being selected.
2. SCAT2/SCAT2_2/SCAT2_3—prize award symbols that award the prize value of an overlay prize symbol when landed in the same position as explained in further detail below. SCAT2_2 and SCAT2_3 award the overlay prize symbol's value multiplied by 2 and 3 respectively.
3. PIC1-PIC5—picture symbols corresponding to the theme.
4. Royal Symbols—A, K, Q, J; and
5. DYN SCAT—a configurable symbol that becomes either SCAT3, SCAT3_2 or SCAT3_3 at the start of each base game instance. As with the SCAT2 symbol, “2” indicates a ×2 multiplier and “_3” indicates a ×3 multiplier. DYN SCAT is used to trigger an overlay game instance as described in further detail below. DYN SCAT appears only on reels 1 and 5 in this example—e.g. at the ninth to eleventh reel strip positions 309 to 311 of the first reel strip 341.

Other reels strips to those illustrated in FIG. 3 can be used, for example, reel strips where two or more wild symbols are placed at consecutive reel strip positions of a reel strip. In some examples other symbol positions may be configurable. In an example, the reel strips include DYN symbols which will be replaced by processor with PIC1, PIC2, PIC3, PIC4 or PIC5 based off a weight table at the start of each base game instance.

Reel strip position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the number of wild symbols (in general, the more wilds there are, the longer the reel strip needs to be to maintain the RTP target), and volatility (in general, the higher the prize value is, the longer the reel strip needs to be to lower the hit rate to maintain the RTP target). In some examples, the reel strips associated with different columns may be of different lengths to one another.

At step 510, processor 204 configures the reel strips for a current base game instance. As indicated above in this respect, the reel strip positions occupied by DYN SCAT become either SCAT3, SCAT3_2 or SCAT3_3 at the start of each spin. In this example, processor 204 conducts a random determination using RNG 212 and a weighted table stored in memory 208 to determine whether that the DYN SCAT symbols will be either SCAT3, SCAT3_2 or SCAT3_3 in a current game instance.

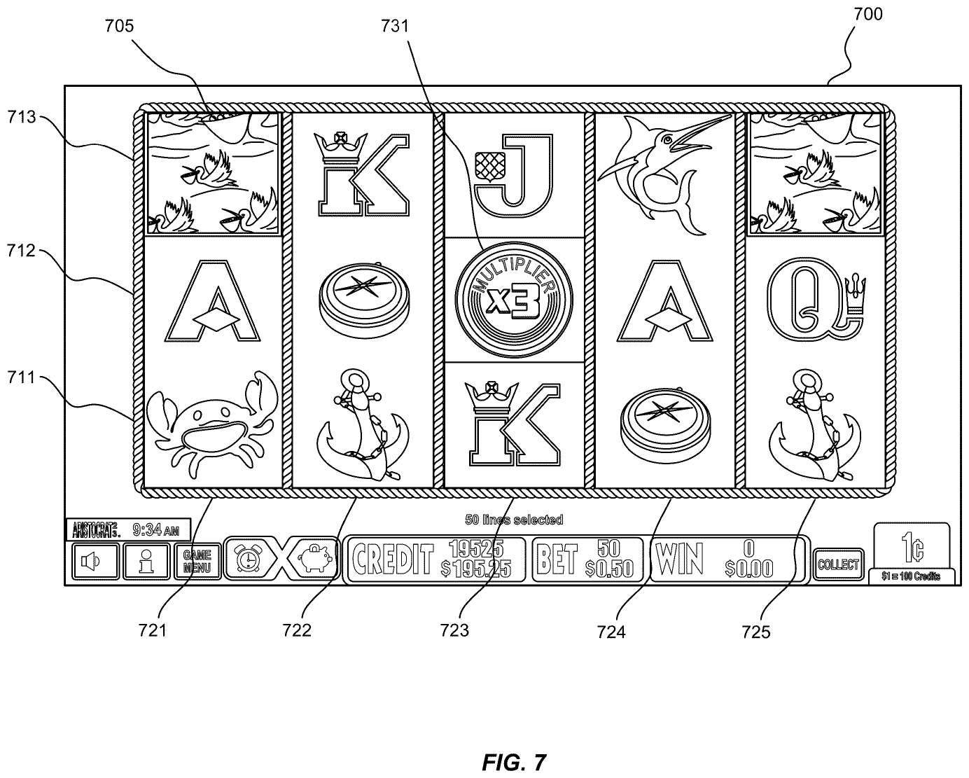

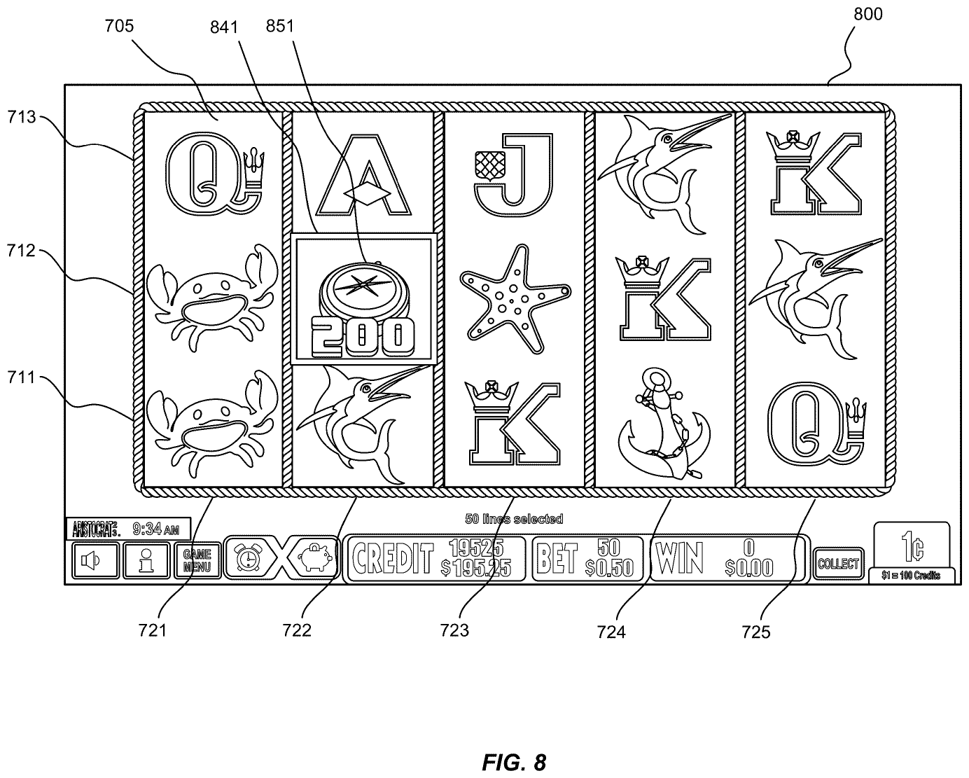

In some embodiments, at step 515, processor 204 determines whether to add one or more overlay prize symbols. In this respect, as expanded upon below, processor 204 selects symbols for game instances by selecting stopping positions of reel strips and controlling display 240 to display the selected symbols at symbol positions. FIG. 7 shows an example screen display 700 of a base game instance where symbols are selected from five reel strips for display in an array of symbol positions having five columns of symbol positions 721-725 with three symbols being selected from each reel strip such that there are also three rows 711-713 of symbol positions in the array or “reel window” 705. In this implementation, overlay prize symbols are independent of the symbols on the reel strips and are added to the display 240 separately. They are referred to a “overlay” symbols because at least some of the time, processor 204 controls the display to display the overlay prize symbols in conjunction with any symbol selected from reel strips, for example, by displaying the overlay prize symbol as superimposed on the underlying symbol. FIG. 8 shows an example of an overlay prize symbol 841 having a value of 200 credits. Overlay prize symbol 841 is superimposed on an underlying PIC symbol 851, in this example, a symbol that represents a compass.

In an example, processor 204 determines whether to add a new overlay prize symbol by conducting random determinations using RNG 212 based on a series of weight tables stored in memory 208 that control the probability of where one or more overlay prize symbols will be added (e.g. in which column 721-725 and at what position of that column) and the value of the overlay prize symbol. In some examples, at least some of the possible values of the overlay prize symbols may be proportional to an amount wagered.

Upon making a positive determination at step 515, processor 204 controls the display to add the overlay prize symbol at step 520. In this respect, FIG. 8 is an example game instance after the game instance of FIG. 7. Referring to the example screen display 800 of FIG. 8, 200 credit overlay prize symbol 841 has been added at a middle position of second column 722 of symbol positions.

In some implementations, once added, overlay prize symbols may be retained by processor 204 in subsequent game instances and be added by processor 204 to the same symbol position or a different symbol position on display 240 at step 520 in that subsequent game instance.

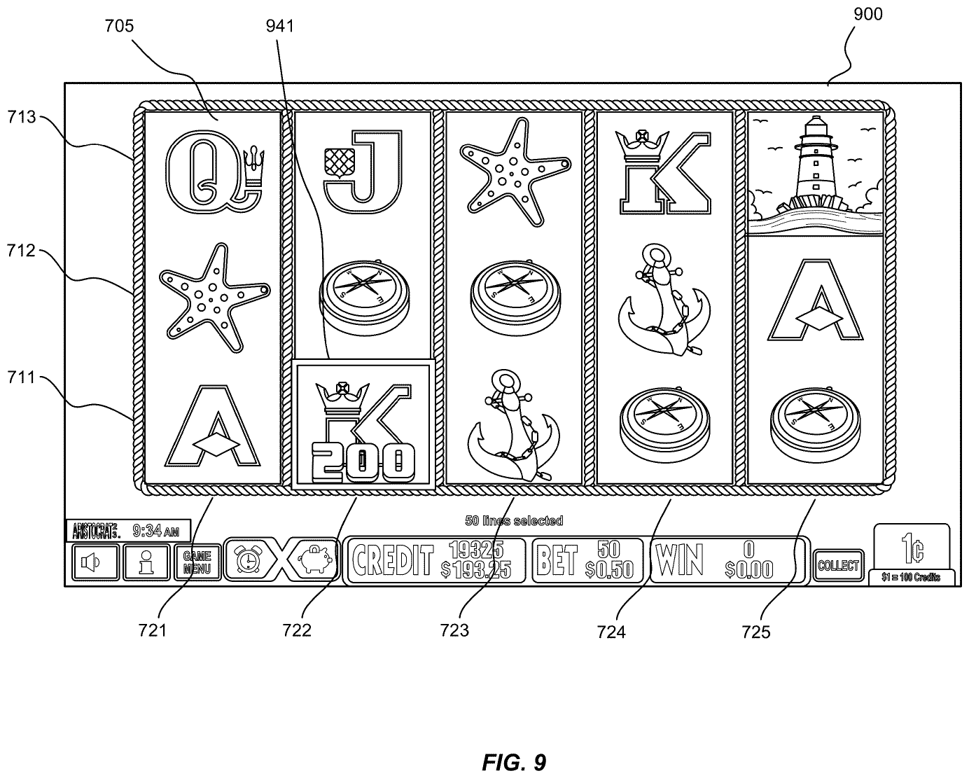

In an implementation, overlay prize symbols are added in a subsequent game instance upon a defined movement applied by processor 204 meeting a movement criterion with respect to a subsequent game instance. In an example, overlay prize symbols move down one position each spin until the movement causes them to move out of a displayed symbol position. In this example, the movement criterion is that the overlay prize symbol can be moved downward by one symbol position and still be at a displayed symbol position. Other defined movements may be used in other implementations, e.g. lateral movements, randomly selected movements, upward movements, diagonal movements, etc. FIG. 9 is an example screen display 900 of a game instance following that displayed in FIG. 8, showing that overlay prize symbol 941 has moved downward by one symbol position relative to FIG. 8. It will be appreciated that in the next game instance, overlay prize symbol 941 will be removed because applying the defined movement will move the overlay prize symbol 941 out of the reel window 705.

In some implementations, overlay prize symbols may also be added outside of the reel window 705, for example, in an implementation where overlay prize symbols move down one position, overlay prize symbols may be added above the reel window 705 but be hidden until the processor 204 applies a defined movement that causes the relevant overlay prize symbol(s) to move down onto the top row 713 of the reel window 705. In some implementations where overlay prize symbols can persist, their persistence may be contingent on processor 204 determining that a same wager has been placed as in a prior game instance. In this respect, in some implementations, processor 204 maintains a persistent state defining the position of each overlay prize symbol in memory 208 for each bet combination defined by a selected line, bet and denomination option such that the persistent state will be used for a next same bet combination.

At step 525, processor 204 selects symbols for a spinning reel base game instance using the configured reel strips and controls the display 240 to display the selected symbols. As described above, FIG. 7 shows an example screen display 700 where symbols are selected from five configured reel strips for display in five columns of symbol positions 721-725.

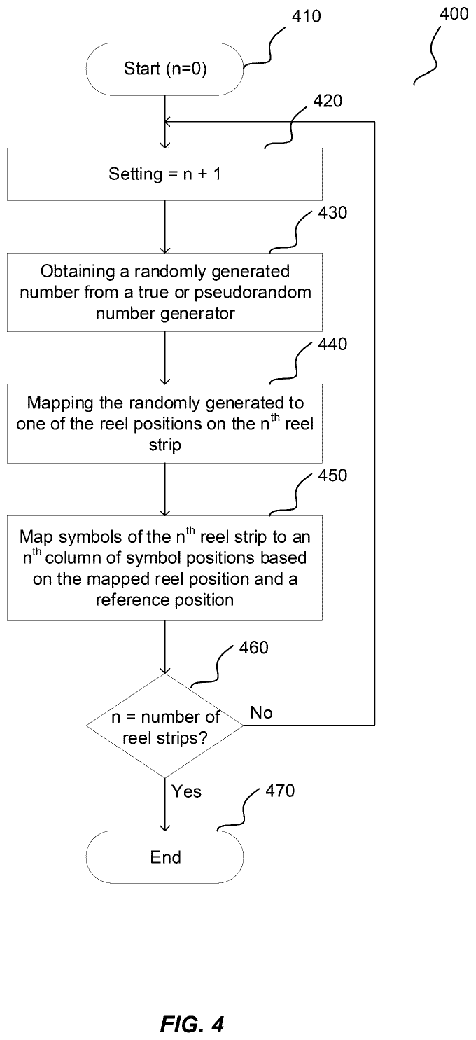

FIG. 4 is a flow chart of an example method 400 carried out by the processor 204 to select symbols at step 525 from reel strips configured at step 510. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position (and hence the symbol at this position) is mapped to the bottom symbol position of the column. Referring to the example reel strips of FIG. 3, if the value returned by the RNG 212 is mapped to reel position 324 when three symbols are being selected from each reel, then for the first reel strip 341, “Q” is mapped to a bottom symbol position in bottom row 711, “J” symbol is mapped to a middle symbol position in middle row 712, and “A” symbol is mapped to a top symbol position in top row 713.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions.

After the symbols of all reel strips have been mapped to symbol positions, the processor 204 controls display 240 to display them at the symbol positions as shown in FIG. 7.

After the symbols are selected, at step 530, the processor 204 evaluates the selected symbols for one or more winning combinations based on a pay table stored in memory 208. In this example, processor 204 applies a “pay line” type evaluation by processing the selected symbols to identify instances of the same symbol appearing one defined pay lines comprising one symbol from of the columns 721-725 starting with (and including) the first column. Upon there being one or more winning combinations, processor 204 makes an award, for example, by adding credit amounts defined by the pay table and the amount wagered to a win meter or a credit meter in memory 208.

At step 535, processor 204 determines whether the selected symbols include a prize award symbol at a symbol position that corresponds to an overlay prize symbol. Accordingly in the example of FIG. 7, processor 204 will make a negative determination at step 535 because while a prize award symbol 731 is displayed (in this example, a SCAT2_3 symbol taking the form of a coin symbol with the text “Multiplier ×3” on it), it is not displayed at a symbol position occupied by an overlay prize symbol.

In the examples of FIGS. 8 and 9, processor 204 will also make a negative determination at step 535 because the symbol positions at which overlay prize symbols 941 are overlaying are not populated with underlying prize award symbols.

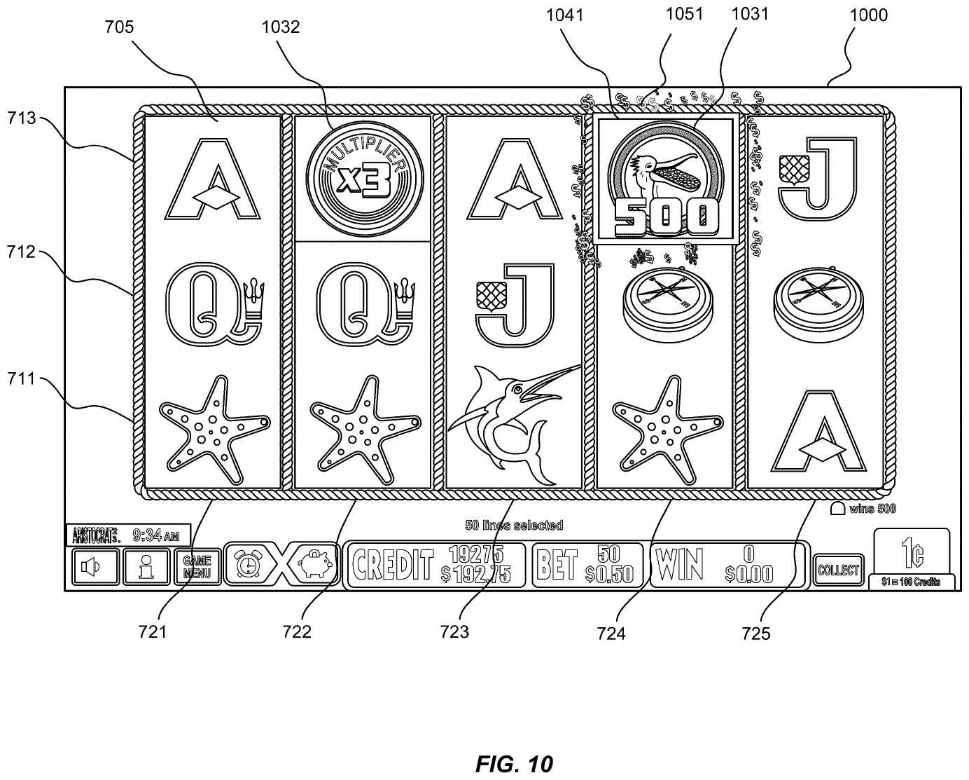

FIG. 10 shows a further example screen display 1000 following symbol selection at step 525. In this example, processor 204 will make a positive determination at step 535 because a prize award symbol 1031 is displayed at a same symbol position at which an overlay prize symbol 1041 is displayed. In this example, a SCAT2 symbol taking the form of a coin symbol is displayed at a top symbol position in the fourth column 724 occupied by a 500 credit value, overlay prize symbol 1041. In the embodiment shown, the positive determination is featured with highlights 1051 in the form of a number of “$” symbols.

Upon making a positive determination at step 535, processor 204 proceeds to step 540 and makes an award based on the prize value of the overlay prize symbol, e.g. by adding the award to a win or credit meter in memory 208. In this example, processor 204 awards 500 credits. When the prize award symbol includes multiplier, processor 204 awards the value of the overlay prize symbol multiplied by the value of the multiplier. In this example, this provides an additional prize award mechanic separate to the evaluation of winning combinations in the selected symbols.

While the above example shows overlay prize symbols having credit values, in some implementations other prize types can be used, such as jackpots or bonus prizes. In some examples, the weighted tables in memory 208 are configured so that overlaying jackpot prizes can only be added at a limited number of symbol positions, e.g. only at the bottom of fourth column 724 and only in base game instances. In some examples, the reel strips may be configured so as not to include any multiplier type prize award symbols on a reel strip corresponding to a column in which an overlaying jackpot prize may be added. In some examples, jackpot overlay prize symbols may be added independently of all other prizes such that jackpot overlay prize symbols may appear merged with other overlay prize symbols.

At step 545, processor 204 determines whether a trigger condition defined by instructions in memory 208 is met. As indicated above, in an example implementation, SCAT3, SCAT3_2, or SCAT3_3 can trigger an overlay game instance. In this example, the trigger condition defined by instructions in memory 208 is that following symbol selection at step 525, all symbol positions of the first column 721 and fifth column 725 are occupied by one of SCAT3, SCAT3_2, or SCAT3_3. In other implementations, same or different types of symbols occupying the same or different predetermined symbol positions may also constitute trigger conditions. For example, other trigger conditions may include a specific prize award symbols being displayed or populated in a predetermined symbol position, a predetermined plurality of prize award symbols being displayed or populated, a predetermined amount of wager being placed at a specific time, and the like.

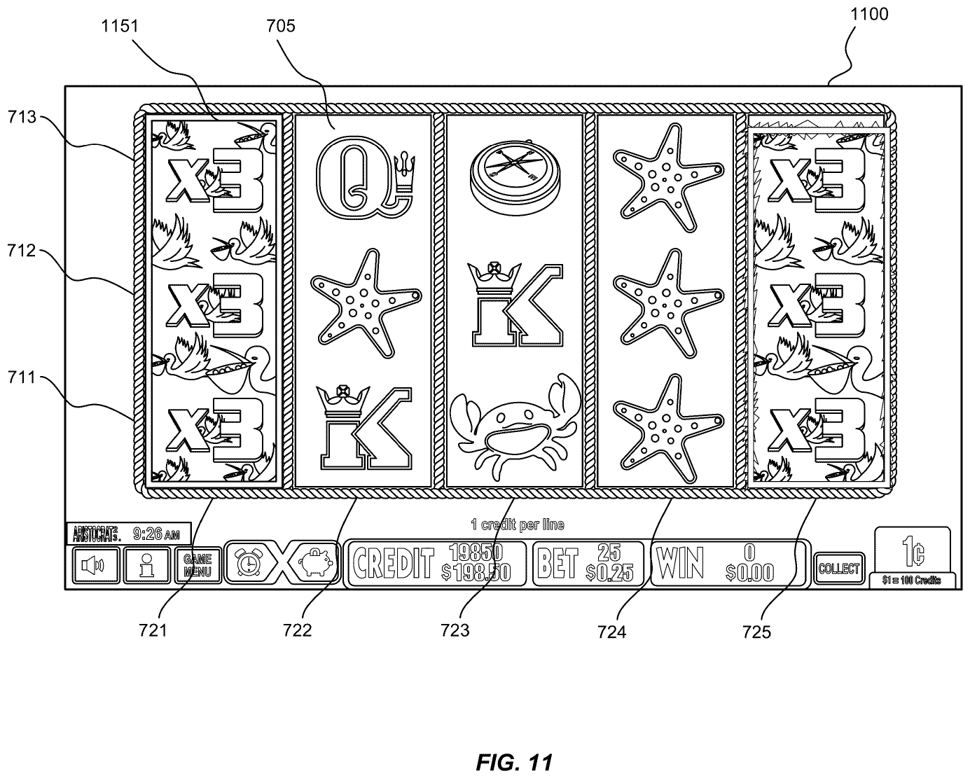

FIG. 11 is an example screen display 1100 where processor 204 will make a positive determination at step 545 that a trigger condition has been met as the SCAT3_3 symbol has been selected at all symbol positions of the first column 721 and fifth column 725. In this regard, other events may meet the trigger conditions. For example, the trigger event may include a winning combination on a payline, one or more specific symbols being displayed at one or more predetermined symbol positions, a particular outcome or set of outcomes, and the like.

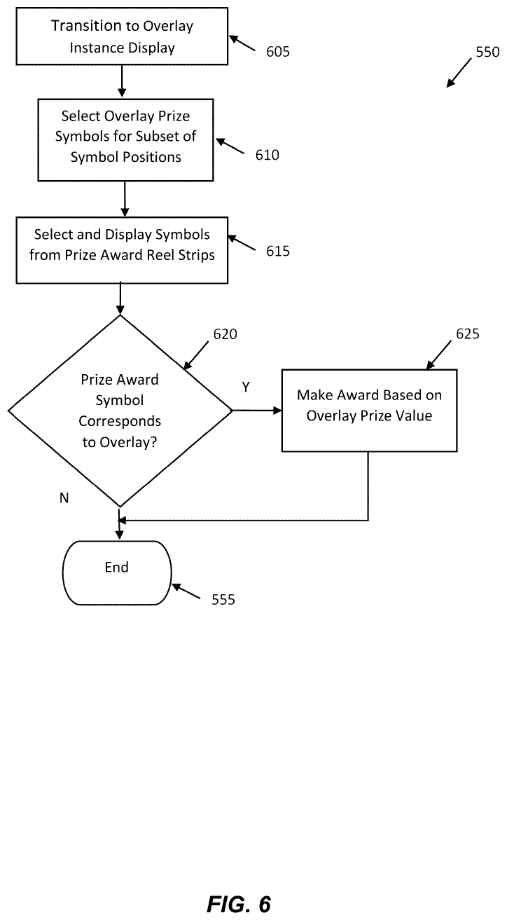

In response to making a positive determination at step 545, processor 204 conducts an overlay game instance at step 550. Further detail of an example method of operating a gaming device to implement an overlay game instance is shown in FIG. 6.

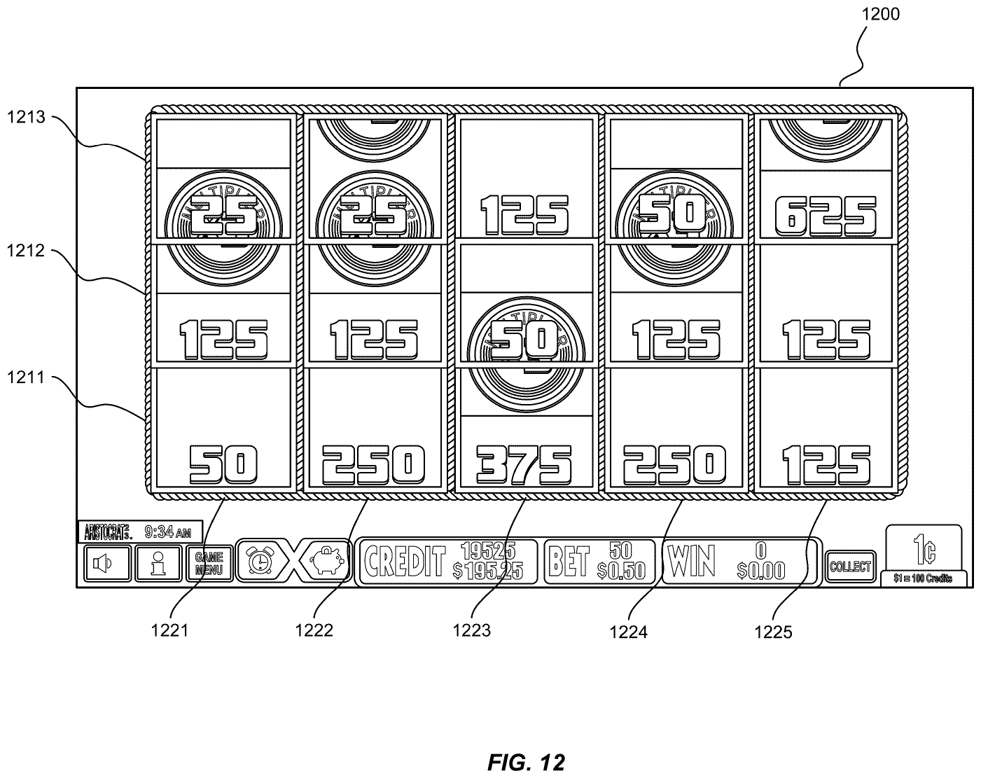

At step 605, processor 204 controls the display 240 to change or transition to an overlay game instance display as shown by example screen display 1200 of FIG. 12. In this example, a same number of symbol positions arranged in five columns 1221-1225 and three rows 1211 is used for the overlay game instance. However, in other implementations, a number of symbol positions may change for the overlay game instances, for example to three columns and three rows. In some implementations, existing overlay prize symbols may be removed during the transition.

At step 610, processor 204 selects overlay prize symbols to be displayed at each symbol position. For example, by making a random selection using RNG 212 and a weighted table in memory 208. In another implementation, processor 204 may randomly select from predefined arrangements of overlay prize symbols. In alternative implementations, processor 204 may select overlay prize symbols to be displayed at a subset of the symbol positions. In some implementations, a subset or all of the overlay prize symbols displayed at the symbol positions at step 520 (of FIG. 5), as described above, may be removed and replaced by a new selection of overlay prize symbols at step 610. In some other implementations, a subset or all of the overlay prize symbols displayed at the symbol positions at step 520 (of FIG. 5), as described above, may be overlaid and optionally merged with the new selection of overlay prize symbols at step 610. In some implementations, the new selection of overlay prize symbols may be selected from the same overlay prize symbol sets that produce the overlay prize symbols being replaced. In other implementations, the new selection of overlay prize symbols may be selected from different overlay prize symbol sets that produce the overlay prize symbols being replaced. In still other implementations, data indicative of the new selection of overlay prize symbols may be transmitted from one or more remote servers, such as, for example, the central determination gaming system server 106, the ticket-in-ticket-out (TITO) system server 108, the player tracking system server 110, the progressive system server 112, and/or the casino management system server 114 as shown in FIG. 1.

In an implementation, step 610 can be conducted by processor 204 prior to or while, processor 204 is transitioning to the overlay prize game instance display so that the prize values of the overlays are immediately visible on display 240 following the transition. In an example, when the processor 204 controls the display 240 to transition, prize award reels are animated as being spun or spinning relative to the symbol positions, and being stopped relative to the symbol positions.

In this respect, as illustrated in FIG. 12, in the overlay game instance illustrated by example screen display 1200, processor 204 selects from a set of prize award reel strips stored in memory 204 at step 615. In an example, there are five prize award reel strips corresponding to respective ones of the five columns. In an implementation, each reel strip comprises prize award symbols and blank symbol positions. In some implementations, all of the prize award symbols are the same. In some examples, the prize award symbols are dynamically configured by processor 204 in a manner similar to the DYN SCAT symbols above, for example, by selecting using a weighted table in memory 208 and RNG 212 whether the prize award symbols will be SCAT2, SCAT2_2, or SCAT2_3.

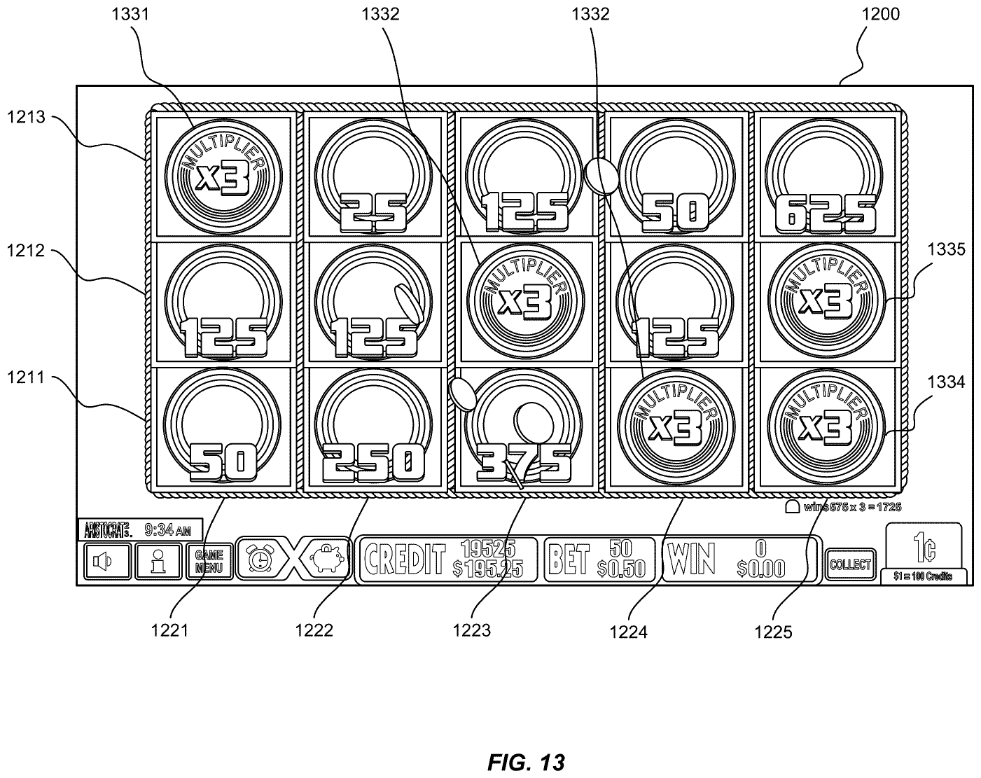

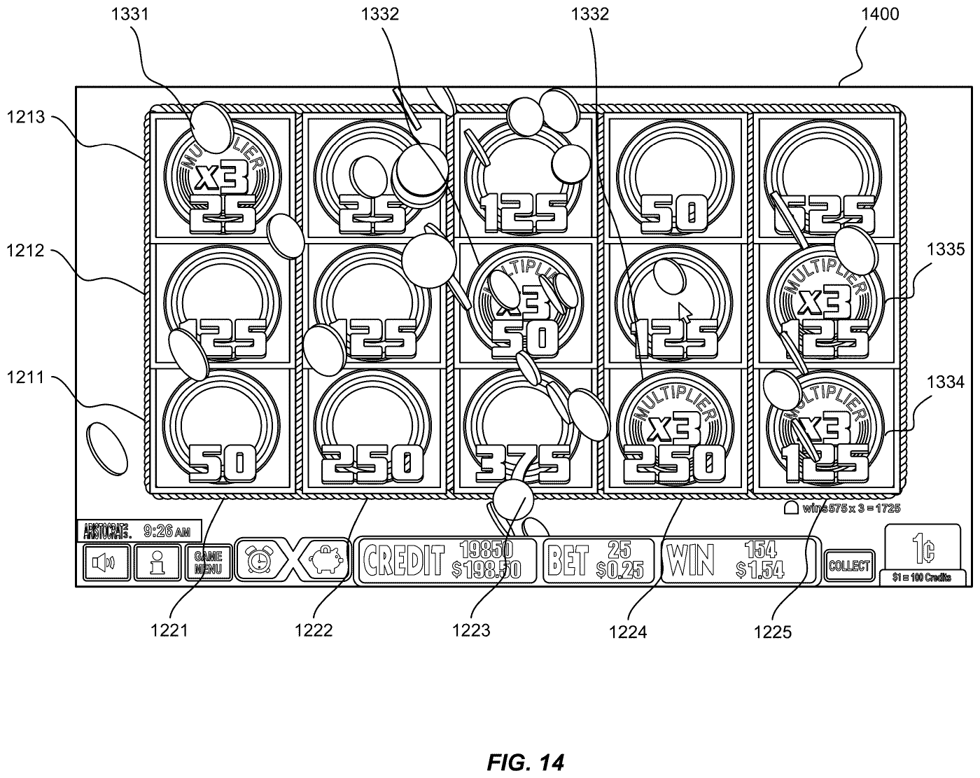

In an example, processor 204 selects stopping positions for each reel strip using the method described in relation to FIG. 4 above. FIG. 13 is an example screen display of an outcome of such a selection process populated with five SCAT2_3 symbols 1331-1335 selected. Processor 204 then determines whether the selected symbols result in one or more prize award symbols corresponding to an overlay symbol and upon making a positive determination proceeds to step 625 and makes an award based on the overlay prize values at the symbol positions at which prize award symbols are selected. In this example, as best seen in screen display 1400 of FIG. 14, processor 204 will make awards of:
1. 25×3=75 credits for first prize award symbol 1331;
2. 50×3=150 credits for second prize award symbol 1332;
3. 250×3=750 credits for third prize award symbol 1333;
4. 125×3=375 credits for fourth prize award symbol 1334; and
5. 125×3=375 credits for fifth prize award symbol 1335.

The overlay prize symbols of FIG. 12 are omitted in FIG. 13 for clarity purposes to show the underlying prize award symbols. FIG. 14 also highlights all the symbol positions, such as symbol position 1451, where overlaying prize symbols overlays underlying prize award symbols. The mechanic enables varying prize awards as the mechanic has multiple factors that influence the awarded prize.

### Example Embodiments

An example embodiment provides a gaming device comprising: a display; a random number generator; a processor; and memory storing (i) reel strip data defining reel strips including prize award symbols, and (ii) instructions which, when executed by the processor, cause the processor to: control the display to display a plurality of columns of symbol positions; determine whether to add one or more overlay prize symbols, and upon making a positive determination, control the display to display each overlay prize symbol at a respective symbol position of the plurality of symbol positions, each overlay prize symbol indicating a prize value and enabling any underlying symbol to be viewed on the display, select, using the random number generator, stopping positions for the reel strips relative to the symbol positions; control the display to display the reel strips stopped at the selected stopping positions; and upon a prize award symbol being displayed at a symbol position at which an overlay prize symbol is displayed when the reel strips are displayed as stopped, make an award of at least the prize value indicated by the overlay prize symbol.

Another example embodiment provides a method of operating a gaming device comprising a display, a random number generator, and memory storing reel strip data defining prize award reel strips including prize award symbols, the method comprising: controlling the display to display a plurality of columns of symbol positions; determining whether to add one or more overlay prize symbols, and upon making a positive determination, controlling the display to display each overlay prize symbol at a respective symbol position of the plurality of symbol positions, each overlay prize symbol indicating a prize value and enabling any underlying symbol to be viewed on the display, selecting, using the random number generator, stopping positions for the reel strips relative to the symbol positions; controlling the display to display the reel strips stopped at the selected stopping positions; and upon a prize award symbol being displayed at a symbol position at which an overlay prize symbol is displayed when the reel strips are displayed as stopped, making an award of at least the prize value indicated by the overlay prize symbol.

An example embodiment provides a system comprising: at least one display; a random number generator; one or more processors; and at least one memory storing (i) reel strip data defining reel strips including prize award symbols, and (ii) instructions which, when executed by the one or more processors, cause the one or more processors to: control the at least display to display a plurality of columns of symbol positions; determine whether to add one or more overlay prize symbols, and upon making a positive determination, control the display to display each overlay prize symbol at a respective symbol position of the plurality of symbol positions, each overlay prize symbol indicating a prize value and enabling any underlying symbol to be viewed on the display, select, using the random number generator, stopping positions for the reel strips relative to the symbol positions; control the at least one display to display the reel strips stopped at the selected stopping positions; and upon a prize award symbol being displayed at a symbol position at which an overlay prize symbol is displayed when the reel strips are displayed as stopped, make an award of at least the prize value indicated by the overlay prize symbol.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming device comprising:
a display having a plurality of symbol positions; and
a gaming controller having a processor and memory storing data indicative of a plurality of prize award reel strips including a plurality of prize award symbols, and instructions, which, when executed, cause the processor to at least:
control the plurality of symbol positions to animate at one or more of a plurality of overlay prize symbols, the plurality of overlay prize symbols having a plurality of prize values, respectively, and enabling an underlying symbol to be viewable on the display, respectively,
control the display to animate the prize award reel strips having prize award symbols being spun and stopped at a plurality of stopping positions selected for the prize award reel strips with respect to the symbol positions using a random number generated by a random number generator and a weighted table to maintain a return-to-player target, and
control the display to animate a win indicative of the prize values on the overlay prize symbols at the symbol positions that overlay the prize award symbols at the stopping positions selected.

2. The gaming device as claimed in claim 1, wherein the prize award symbols include a multiplier prize award symbol having a multiplier, and wherein the instructions, when executed, cause the processor to, upon the multiplier prize award symbol being displayed at one of the symbol positions overlaid with a first of the overlay prize symbols displayed, control the display to animate an award based on a value on the first of the overlay prize symbols multiplied by the multiplier.

3. The gaming device as claimed in claim 1, wherein the instructions, when executed, cause the processor to control the display to display the overlay prize symbols at all of the symbol positions.

4. The gaming device as claimed in claim 1, wherein the instructions, when executed, cause the processor to control the display to display the overlay prize symbols at the stopping positions selected for the prize award reel strips reel strips in response to a trigger condition being met in a base game instance.

5. The gaming device as claimed in claim 4, wherein the prize award reel strips further includes base game strips having trigger symbols, wherein the instructions, when executed in the base game instance, cause the processor to:
control the display to animate the base game strips being spun and stopped at the stopping positions selected for the base game strips relative to the symbol positions using the random number generator and a second weighted table,
control the display to highlight a winning combination of symbols evaluated based on the stopping positions selected for the base game strips, and
determine whether the stopping positions selected for the base game strips meet the trigger condition.

6. The gaming device as claimed in claim 5, wherein the instructions, when executed in the base game instance, cause the processor to:
determine whether to display one or more of the overlay prize symbols during the base game instance,
when one or more of the overlay prize symbols are to be displayed, control the display to display one or more of the overlay prize symbols at one or more of the symbol positions, and
when one or more of the prize award symbols are displayed in one of the symbol positions having a respective overlay prize symbol in the base game instance, control the display to highlight a second win based on a respective prize value displayed on the respective overlay prize symbol.

7. The gaming device as claimed in claim 6, wherein the instructions, when executed in the base game instance, cause the processor to determine whether to display one or more of the overlay prize symbols during the base game instance based on a random determination using the random number generator.

8. A method of animating an award on a gaming device, the method comprising:
animating at a plurality of symbol positions on the gaming device one or more of a plurality of overlay prize symbols, the overlay prize symbols displaying prize values and enabling an underlying symbol to be viewable on the display;
animating on the gaming device a plurality of prize award symbols on a plurality of prize award reel strips underlying one or more of the plurality of overlay prize symbols, the plurality of prize award symbols on the plurality of prize award reel strips being selected using a random number generated by a random number generator and a weighted table to maintain a return-to-player target; and
animating on the gaming device a win indicative of the prize values on the overlay prize symbols corresponding to the prize award symbols underlying the overlay prize symbols.

9. The method as claimed in claim 8, wherein the prize award symbols include a multiplier prize award symbol having a multiplier, further comprising upon the multiplier prize award symbol being displayed at one of the symbol positions overlaid with a first of the overlay prize symbols displayed, animating a second win based on a value on the first of the overlay prize symbols multiplied by the multiplier.

10. The method as claimed in claim 8, further comprising displaying the overlay prize symbols at all of the symbol positions.

11. The method as claimed in claim 8, further comprising displaying the overlay prize symbols underlying the prize award symbols selected in response to a trigger condition being met in a base game instance.

12. The method as claimed in claim 11, wherein the prize award reel strips further includes base game strips having trigger symbols during the base game instance, further comprising:
animating the base game strips being spun and stopped with respect to the symbol positions using the random number generator and a second weighted table;
highlighting a winning combination of symbols evaluated based on the prize award symbols underlying the overlay prize symbols; and
determining whether the prize award symbols underlying the overlay prize symbols meet the trigger condition.

13. The method as claimed in claim 12, further comprising:
determining whether to display one or more of the overlay prize symbols during the base game instance;
when one or more of the overlay prize symbols are to be displayed, displaying one or more of the overlay prize symbols at one or more of the symbol positions; and
when one or more of the prize award symbols are displayed in one of the symbol positions having a respective overlay prize symbol in the base game instance, highlighting a second win based on a respective prize value displayed on the respective overlay prize symbol.

14. The method as claimed in claim 13, further comprising determining whether to display one or more of the overlay prize symbols during the base game instance based on a random determination using the random number generator.

15. A non-transitory computer-readable medium comprising a plurality of instructions for conducting a game on a gaming system including a display and a game controller, the instructions, which, when executed, cause the game controller to perform the steps of:
controlling the display to animate at a plurality of symbol positions one or more of a plurality of overlay prize symbols, the plurality of overlay prize symbols having a plurality of prize values, respectively, and enabling an underlying symbol to be viewable on the display;
controlling the display to underlay the plurality of symbol positions with a plurality of prize award symbols on a plurality of prize award reel strips selected using a random number generated by a random number generator and a weighted table to maintain a return-to-player target; and
controlling the display to animate a win indicative of the prize values on the plurality of overlay prize symbols corresponding to the plurality of prize award symbols selected at the plurality of symbol positions.

16. The non-transitory computer-readable medium as claimed in claim 15, wherein the prize award symbols include a multiplier prize award symbol having a multiplier, and wherein the instructions, when executed, cause the game controller to perform the step of, upon the multiplier prize award symbol being displayed at one of the plurality of symbol positions overlaid with a first of the plurality of overlay prize symbols displayed, controlling the display to animate an award based on a value on the first of the plurality of overlay prize symbols multiplied by the multiplier.

17. The non-transitory computer-readable medium as claimed in claim 15, wherein the instructions, when executed, cause the game controller to perform the step of controlling the display to display the plurality of overlay prize symbols at all of the plurality of symbol positions.

18. The non-transitory computer-readable medium as claimed in claim 15, wherein the instructions, when executed, cause the game controller to perform the step of controlling the display to display the plurality of overlay prize symbols underlying the prize award symbols selected in response to a trigger condition being met in a base game instance.

19. The non-transitory computer-readable medium as claimed in claim 18, wherein the prize award reel strips further includes base game strips having trigger symbols, wherein the instructions, when executed in the base game instance, cause the game controller to perform the steps of:
controlling the display to animate the base game strips being spun and stopped with respect to the plurality of symbol positions using the random number generator and a second weighted table,
controlling the display to highlight a winning combination of symbols evaluated based on the plurality of prize award symbols selected at the plurality of symbol positions, and
determining whether the plurality of prize award symbols selected at the plurality of symbol positions meet the trigger condition.

20. The non-transitory computer-readable medium as claimed in claim 19, wherein the instructions, when executed in the base game instance, cause the game controller to perform the steps of:
determining whether to display one or more of the plurality of overlay prize symbols during the base game instance,
when one or more of the plurality of overlay prize symbols are to be displayed, controlling the display to display one or more of the plurality of overlay prize symbols at one or more of the plurality of symbol positions, and
when one or more of the prize award symbols are displayed in one of the plurality of symbol positions having a respective overlay prize symbol in the base game instance, controlling the display to highlight a second win based on a respective prize value displayed on the respective overlay prize symbol.
